(19) United States
(12) Patent Application Publication
(10) Pub. No.: US 2024/0400743 A1
(43) Pub. Date: Dec. 5, 2024

(54) Fully Hydrogenated Branched Styrenic Block Copolymer

(71) Applicant: Kraton Corporation, The Woodlands, TX (US)

(72) Inventors: Robert Bening, Houston, TX (US); Claire Miller, Houston, TX (US)

(73) Assignee: Kraton Corporation, The Woodlands, TX (US)

(21) Appl. No.: 18/731,435

(22) Filed: Jun. 3, 2024

Related U.S. Application Data
(60) Provisional application No. 63/505,440, filed on Jun. 1, 2023.

(51) Int. Cl. C08F 297/04

(52) U.S. Cl. CPC C08F 297/044; C08F 2800/20

(57) ABSTRACT

A fully hydrogenated branched block copolymer (f-HbBC) is disclosed. The f-HbBC comprises a mixture of radial block copolymers having a general structure of (S-B)ₙX(s-B)ₘ, (s-B)_{z}X, and mixtures thereof. Prior to hydrogenation, each block S and “s” is a polymer block of a vinyl aromatic monomer, and the block B is a polymer block of a conjugated diene monomer. The mixture of radial block copolymers comprises at least 70 wt. % of a poly(vinylcyclohexane) content, and <30 wt. % of a hydrogenated polymer block of a conjugated diene monomer. One or more radial block copolymers in the mixture have a molecular weight of at least 120 kg/mol and at least 60% of radial block copolymers in the mixture have a molecular weight of >100 kg/mol. The mixture contains <40 wt. % of (s-B)_{z}X structure. The f-HbBC has a T_{g} of >145° C. and a polydispersity index of >1.20.

### RELATED APPLICATIONS

This application claims benefit to U.S. provisional application No. 63/505,440, filed on Jun. 1, 2023, incorporated herein by reference.

### FIELD

The disclosure relates to fully hydrogenated branched block copolymers, methods of preparation, and applications thereof.

### BACKGROUND

Branched multi-modal (or polymodal) polymers are known in the art, including asymmetrical branched polymers having a high molecular weight (MW) portion and a low molecular weight portion of monovinyl-substituted aromatic block designed for articles with low haze, high flex modulus and high hardness. Vinyl aromatic polymers were subsequently hydrogenated to produce clear, tough plastics with a higher glass transition temperature (T_{g}) than their non-hydrogenated polymer counterparts. To further toughen these materials, hydrogenated block copolymers of vinyl aromatics and conjugated dienes were developed. However, polymer materials having higher T_{g} and relatively low haze are still desired.

There is still a need for block copolymers, particularly fully hydrogenated branched block copolymers, with high hydrogenation levels and improved processability, mechanical, and optical properties.

### SUMMARY

In one aspect, the disclosure relates to a fully hydrogenated branched block copolymer (f-HbBC), comprising, consisting essentially of, or consists of a mixture of radial block copolymers having a general structure of (S-B)ₙX(s-B)ₘ, (s-B)_{z}X, and mixtures thereof. Prior to hydrogenation, each block S and “s” independently is a polymer block of a vinyl aromatic monomer, and each block B is a polymer block of a conjugated diene monomer, X is residue of a coupling agent, m>n, n≥1, m=1 to 20, z=2 to 4, and m+n≥3. After hydrogenation, the radial block copolymers demonstrating a plurality of peaks on a GPC curve. The mixture comprises at least 70 wt. % of a poly(vinylcyclohexane) content, and less than 30 wt. % of a hydrogenated polymer block of a conjugated diene monomer, based on total weight of the mixture. At least 60% of radial block copolymers in the mixture have a molecular weight (Mₚ) of >100 kg/mol, with remainder having a molecular weight (Mₚ) of <100 kg/mol. At least 30% of radial block copolymers in the mixture have a molecular weight (Mₚ) of at least 100 kg/mol, with remainder having a molecular weight (Mₚ) of <100 kg/mol. Less than 40 wt. % of the mixture having a general structure of (s-B)_{z}X. The f-HbBC has a polydispersity index of >1.20, a glass transition temperature (T_{g}) of >145° C., a MFR of >0.1 g/10 minutes, measured at 260° C. with 5 kg load, and an un-notched Charpy Impact strength of at least 20 KJ/m² measured at 25° C.

In a second aspect, the mixture has a weight ratio of radial block copolymers having a structure of (S-B)ₙX(s-B)ₘ to radial block copolymers having a structure of (s-B)_{z}X of 1:1 to 20:1.

In a third aspect, at least one radial block copolymer has a molecular weight (Mₚ) of 120 to 250 kg/mol.

In a fourth aspect, the mixture of radial block copolymers comprises 60 to 80% of radial block copolymers having a molecular weight (Mₚ) of >100 kg/mol and 20 to 40% of radial block copolymers having a molecular weight (Mₚ) of <100 kg/mol.

### BRIEF DESCRIPTION OF DRAWINGS

FIG. 1 is a Gel Permeation Chromatography (GPC) curve of an embodiment of a f-HbBC having a mixture of radial block copolymers, with the different structures being represented by the plurality of modes (peaks) on the GPC curve.

### DESCRIPTION

The following terms will be used throughout the specification.

“Consisting essentially of” means that the claimed composition primarily contains the specified materials, with allowances for additional components that do not materially affect novel characteristics or function of the claimed invention, with the additional components, if present, in an amount of <30%, or <20%, or <10%.

“At least one of [a group such as A, B, and C]” or “any of [a group such as A, B, and C]” means a single member from the group, more than one member from the group, or a combination of members from the group. For example, at least one of A, B, and C includes, for example, A only, B only, or C only, as well as A and B, A and C, B and C; or A, B, and C, or any other all combinations of A, B, and C. In another example, at least one of A and means A only, B only, as well as A and B.

A list of embodiments presented as “A, B, or C” is to be interpreted as including the embodiments, A only, B only, C only, “A or B,” “A or C,” “B or C,” or “A, B, or C.”

“Any of A, B, or C” refers to one option from A, B, or C.

“Any of A, B, and C” refers to one or more options from A, B, and C.

“Vinyl content” refers to the content of a conjugated diene that is polymerized via 1,2-addition in case of butadiene, or via 3,4-addition in case of isoprene, resulting in a monosubstituted olefin, or vinyl group, adjacent to the polymer backbone. Vinyl content can be measured by proton NMR.

“Coupling efficiency,” expressed as % CE, is calculated using the values of the wt. % of the coupled polymer and the wt. % of the uncoupled polymer. The wt. % of the coupled polymer and the uncoupled polymer are determined using the output of the differential refractometer detector. The intensity of the signal at a specific elution volume is proportional to the amount of material of the molecular weight corresponding to a polystyrene standard detected at that elution volume. The area under the curve spanning the MW range corresponding to coupled polymer is representative of the wt. % coupled polymer, and likewise for the uncoupled polymer. % CE is given by 100 times (wt. % of coupled polymer/wt. % of coupled polymer+wt. % of uncoupled polymer). Coupling efficiency can also be measured by calculating data from GPC, dividing the integrated areas below the GPC curve of all coupled polymers (including two-arm, three-arm, four arm, etc. copolymers) by the same of the integrated areas below the GPC curve of both coupled and uncoupled polymers.

“Hydrogenation level” refers to the % of original unsaturated bonds which become saturated upon hydrogenation. The level of hydrogenation in hydrogenated vinyl aromatic polymers can be determined using proton NMR. The hydrogenation level in hydrogenated diene polymers can be determined using proton NMR.

“Polystyrene content” or PSC of a block copolymer refers to the wt. % of vinyl aromatic, e.g., polystyrene in the block copolymer, calculated by dividing the sum of molecular weight of all vinyl aromatic blocks by the total molecular weight of the block copolymer. PSC can be determined using any suitable methodology such as proton NMR.

“Poly(vinylcyclohexane) content” or “PVCH content” refers to the wt. % of vinylcyclohexane in the block copolymer. The vinylcyclohexane is formed in the block copolymer by hydrogenation of the vinyl aromatic block. PVCH content is calculated by dividing the sum of molecular weight of all vinylcyclohexane blocks by the total molecular weight of the block copolymer. PVHC content can be determined by proton NMR.

“Molecular weight” or MW refers to the styrene equivalent molecular weight in kg/mol of a polymer block or a block copolymer. MW can be measured with gel permeation chromatography (GPC) using polystyrene calibration standards, such as is done according to ASTM D5296. The GPC detector can be an ultraviolet or refractive index detector or a combination thereof. The chromatograph is calibrated using commercially available polystyrene molecular weight standards. MW of polymers measured using GPC so calibrated are styrene equivalent molecular weights or apparent molecular weights. MW expressed herein is measured at the peak of the GPC trace-and are commonly referred to as styrene equivalent “peak molecular weight,” designated as Mₚ.

“Polydispersity index” or PDI of polymers is a measure of the distribution of molecular weights in a polymer, as an indicator of the range of sizes of the polymer chains. The PDI is calculated as the ratio of the weight average molecular weight (M_{w}) to the number average molecular weight (Mₙ): PDI=M_{w}/Mₙ.

“Radial” refers to, and is used interchangeably with star-shape, symmetrically branched shape, or dissimilarly branched shape, or asymmetrically branched shape.

The disclosure relates to a fully hydrogenated branched block copolymer (f-HbBC) characterized as having excellent high temperature resistance and optical properties (e.g., haze <10%), amongst other characteristics.

(Fully Hydrogenated Branched Block Copolymer (f-HbBC))

The f-HbBC comprises a mixture of radial block copolymers having a general structure of (S-B)ₙX(s-B)ₘ, (s-B)_{z}X, and mixtures thereof, meaning that some radial copolymers having structure of (S-B)ₙX(s-B)ₘ and some having structure of (s-B)_{z}X. X is residue of a coupling agent. The designation of “n,” “m,” and “z” refer the number of “arms” or “branches” in each of the structure. In embodiments, m>n, and (m+n) is ≥3, z is ranging from 2-4, and n≥1, m>0, and m>n. In embodiments, (m+n) is in the range of 3-4 and z in the range of 3-4.

In embodiments, each (S-B)ₙX(s-B)ₘ or (s-B)_{z}X independently has a number of arms (branches) in the range of 2-25, or 2-20, or 2-15, or 2-10, or 2-7.

In embodiments, the radial block copolymers having the structure (S-B)ₙX(s-B)ₘ has m=n, with the value ranging from 1-20, or 2-15, or 3-10, or 4-8.

In embodiments, the radial block copolymers having the structure (S-B)ₙX(s-B)ₘ is present in amounts of 50-80, or 50-70, or 55-65, or >50, or <75 wt. %, based on total weight of the radial block copolymers, with n=1-2 and m=1-3, provided m+n=2-4.

In embodiments, the f-HbBC contains other arm distributions, e.g., (s-B) 4, (s-B) 3, (s-B) 2, etc., and uncoupled arms (e.g., S-B and/or s-B) in amounts of 15-25, or 15-20, or 10-15, or 8-12, or <25 wt. %, based on total weight of the f-HbBC.

In embodiments, radial block copolymers having the structure (s-B) 2× with z=2-4 is present in amounts of 20-40, or 20-35, or 20-30, or <40, or <35, or <30 wt. %, based on total weight of radial block copolymers.

In embodiments, the radial block copolymers having combined (S-B)ₙX(s-B)ₘ and (s-B)_{z}X structures are present in amounts of >70, or >75, or 70-85, or 75-85, or 70-80 wt. %, based on total weight of radial block copolymers.

In embodiments, the f-HbBC has a weight ratio of (S-B)ₙX(s-B)ₘ to (s-B)_{z}X in the range of 1:1 to 20:1, or 1.5:1 to 15:1, or 1.8:1 to 10:1, or 2:1 to 5:1, or 2.2:1 to 4:1, or >1, or >1.5.

In embodiments, prior to hydrogenation, each block S and “s”, independently is a polymer block of a vinyl aromatic monomer, and each block B is a polymer block of a conjugated diene monomer.

In embodiments, the vinyl aromatic monomer is selected from the group consisting of styrene, ortho-methyl styrene, para-methyl styrene, para-ethylstyrene, para-n-propylstyrene, para-iso-propylstyrene, para-tertbutyl styrene, 2,4-dimethyl styrene, alpha-methyl styrene, vinylnaphthalene, vinyltoluene, vinylxylene, isomers of para-decylstyrene, isomers of para-dodecylstyrene, and mixtures thereof.

In embodiments, the conjugated diene monomer is selected from the group consisting of isoprene, 1,3-butadiene, 2,3-dimethyl-1,3-butadiene, 1-phenyl-1,3-butadiene, 1,3-pentadiene, 1,3-hexadiene, 3-butyl-1,3-octadiene, farnesene, myrcene, piperylene, cyclohexadiene, and mixtures thereof.

In embodiments, the mixture of radial block copolymers comprises a poly(vinylcyclohexane) (PVCH) content in amounts of at least 70, or >75, or >80, or >85, or <95, or 70-95, or 70-85, or 70-80 wt. %, based on total weight of the mixture. The PVCH content is the result of hydrogenation of blocks S and “s”. In embodiments, the mixture of radial block copolymers comprises a hydrogenated polymer block of a conjugated diene monomer in amounts of <30, or <25, or <20, or 5-30, or 10-25, or 15-30, or 1-20 wt. %, based on total weight of the mixture.

In embodiments, the f-HbBC has a coupling efficiency (CE) of 70-90%, or 72-85%, or 70-80%, or >70%, or <90%.

In embodiments, the mixture of radial block copolymers contains at least 30%, or >35%, or >40% of radial block copolymers having a molecular weight (Mₚ) of at least 120, or >130, or >140, or >145, or 120-250, or 130-220, or 140-200 kg/mol, as measured by GPC and/or h-NMR, remainder having a molecular weight (Mₚ) of <120 kg/mol.

In embodiments, the mixture of radial block copolymers comprises at least 60%, or >65% or >68%, or >70%, or 60-80% of radial block copolymers having a molecular weight (Mₚ) of >100, or >105, or >110, >120, or >140, or 100-700, or 120-680 kg/mol. In embodiments, the mixture of radial block copolymers comprises ≤40%, or <35% or <32%, or <30%, or 20-40% of radial block copolymers having a molecular weight (Mₚ) of <100 kg/mol, or <95, or <90, <85, or <80, or 5-100, or 6-90, or 10-85, or 5-80 kg/mol.

In embodiments, block S has a higher molecular weight (Mₚ) than the molecular weight (Mₚ) of block “s”. In embodiments, block S has a molecular weight (Mₚ), prior to hydrogenation, of 100-150, or 105-145, or 110-140, or 100-140, or 110-150, or 110-130, or 110-120 kg/mol. In embodiments, the block “s” has a molecular weight (Mₚ), prior to hydrogenation, of 5-15, or 6-14, or 7-12, or 8-11, or >5, or <13 kg/mol.

In embodiments, the f-HbBC has a vinyl content, prior to and after hydrogenation, of 30-80, or 35-75, or 40-70, or 45-65, or 50-60, or >35, or <75 wt. %, based on total weight of the f-HbBC. It should be note that vinyl content does not change much due to the hydrogenation process (e.g., <10% change as compared to value before hydrogenation).

In embodiments, the f-HbBC is fully hydrogenated, meaning each block S and “s” has a hydrogenation level of >90%, or >92%, or >95%, or >97%, or >98%, or >99% or up to 100%. After hydrogenation, polymerized blocks S and “s” become poly(vinylcyclohexane) (PVCH). Each block B has a hydrogenation level of >90%, or >92%, or >95%, or >97%, or >98%, or >99% or up to 100%.

In embodiments, the f-HbBC has a total polystyrene content (PSC), prior to hydrogenation and a total PVCH content after hydrogenation, of at least 70, or >75, or >80, or >85, or <95, or 70-95, or 70-85, or 70-80 wt. %.

In embodiments, the f-HbBC has a molecular weight (Mₚ) of 30-800, or 50-750, or 60-700, or 70-680, or 30-680 kg/mol.

In embodiments, the f-HbBC has a polydispersity index (PDI) of >1.20, or >1.40, or >1.50, or >1.70, or >1.80, or 1.20-3.0, or 1.30-2.80, or 1.50-2.50, or 1.60-2.0, as measured by GPC.

(Methods for Preparing The f-HbBC)

The f-HbBC can be prepared by sequential (or successive) polymerization of the monomers in solution (in solvent) in the presence of an initiator, with stepwise addition of monomer and initiator, followed by coupling of the resulting block copolymers with the coupling agent, and lastly, a hydrogenation step.

It should be noted that the f-HbBC can also be prepared by making the radial block copolymers separately according to the process steps as described above, then blended or mixed together in solution or solid forms to form a f-HbBC with similar properties as a f-HbBC with all radial block copolymers made in-situ in one pot.

In embodiments, the block(S), in the f-HbBC structure (S-B)ₙX(s-B)ₘ is formed first in the sequential polymerization, in a reaction with one or more polymerization initiators, with the addition of vinyl aromatic monomers as needed to grow the block to a desired Mₚ, while simultaneously making the smaller block “s” (as in (s-B) m). For example, 1^{st} initiator charge and a 1^{st} styrene charge are made to produce a polystyrene block(S), followed by a second initiator charge and a second styrene charge, resulting in two populations of styrene blocks, Ss and “s”. The second initiator can be the same or different from the first initiator. The second initiator charge is after the polymerization of the first styrene charge, but before or concurrent with the addition of the second styrene charge.

After essentially all of styrene monomers are consumed and polystyrene blocks with the desired molecular weights are achieved, a conjugated diene monomer is injected. Polymerization is continued for the vinyl aromatic/(alpha-alkylstyrene) copolymer block segment(s) to react with the conjugated diene monomer (and optionally a vinyl aromatic monomer in sequence) to form an intermediate block copolymer having the structures (S-B) and (s-B). At this point, coupling can be utilized by the injection of a suitable coupling agent to cause the formation of the coupled polymer mixture (S-B)ₙX(s-B)ₘ and (s-B)_{z}X.

Process conditions for the sequential polymerization step are similar to those used for anionic polymerizations, preferably at −30° C. to 150° C., or 10° C. to 100° C., or 30° C. to 90° C., in an inert atmosphere, e.g., nitrogen, or under pressure from 0.5 to 65 bars. The polymerization reaction can be continued for 5 minutes to 5 hours, or <12 hours, depending on factors including temperature, monomer concentrations, molecular weight of the polymer, etc.

Following completion of the coupling reaction, the polymerization reaction mixture is optionally treated with a proton donor terminating agent, e.g., water, carbon dioxide, hydrogen, alcohol, phenols, or linear saturated aliphatic mono- or di-carboxylic acids, to react with the polymer initiator prior to hydrogenation.

In embodiments, the polymerization is typically conducted in the presence of a solvent, e.g., ether, benzene, toluene, xylene, ethylbenzene cyclohexane, methylcyclohexane, and the like. In embodiments, a mixed solvent system is used with a saturated hydrocarbon and a straight chain or cyclic ether.

In embodiments, the amount of the solvent used in the polymerization step is 50-90 wt. %, based on total weight of the monomer/solvent mixture.

In embodiments, a copolymerization modifier is employed to increase the vinyl content in the polymer to a desired level. The modifier serves to improve the efficiency of incorporation of the comonomers during copolymerization. Examples include polar modifiers such as dimethyl ether, diethyl ether, ethyl methyl ether, ethyl propyl ether, etc., and chelating polar modifiers such as but not limited to diethoxy propane (DEP), 1,2-dioxy-ethane (dioxo), 1.2-dimethoxy-ethane and ortho-dimethoxy-benzene (ODMB), etc. The amount of modifier required depends upon the type, e.g., non-chelating, polar modifiers such as diethyl ether (DEE) are typically most effective at relatively high levels, 2-20, or 4-8 wt. %, based on weight of the solvent plus the modifier. If chelating, polar modifiers such as DEP or ODMB is used, in lower amount of 50-1000 ppm, or 400-1000 ppm, or 500-700 ppm.

Examples of polymerization initiators include organomonoalkali metal compounds “RM,” wherein R is an alkyl, cycloalkyl, or aryl radical containing 4 to 8 carbon atoms, such as a n-butyl radical, and M is an alkali metal, such as lithium, e.g., alkyl lithium compounds and other organolithium compounds such as s-butyllithium, n-butyllithium, t-butyllithium, amyllithium, and the like, including di-initiators such as the di-sec-butyl lithium adduct of m-diisopropenyl benzene. In embodiments, the initiator is s-butyllithium and/or n-butyllithium. In embodiments, initiator is used in an amount of 0.002-5, or 0.005-4.5, or 0.01-4, or 0.015-3.8, or 0.02-3.5 wt. %, based on total wt. % of monomers to be polymerized.

Examples of coupling agents include di- or multivinylarene compounds; di- or multiepoxides; di- or multiisocyanates; di- or multialkoxysilanes; di- or multiimines; di- or multialdehydes; di- or multiketones; alkoxytin compounds; di- or multihalides, such as silicon halides and halosilanes; mono-, di-, or multianhydrides; di- or multiesters, such as esters of monoalcohols with polycarboxylic acids; diesters which are esters of monohydric alcohols with dicarboxylic acids; diesters which are esters of monobasic acids with polyalcohols such as glycerol; and mixtures of two or more such compounds, among others. The coupling agent can be selected from divinyl benzene, dichloroethane, dibromobutane, and esters of carboxylic acids.

Examples of silane based coupling agents include vinyl trimethoxy silane, vinyl triethoxy silane, vinyl tripropoxy silane, vinyl tributoxy silane, vinyl ethoxy dimethoxy silane, vinyl ethoxy dipropoxy silane, propenyl ethoxy dimethoxy silane, propenyl ethoxy dipropoxy silane, or mixtures thereof. In embodiments, the coupling agent is a tetra-alkoxysilane such as tetra-methoxysilane, and tetra-ethoxysilane, or a tri-alkoxysilane such as methyltrimethoxysilane.

Other examples of coupling agents include polyepoxides, polyisocyanates, polyamines, polyaldehydes, polyhalides, polyanhydrides, polyketones, polypoxyesters, polyesters, and mixtures thereof. In embodiments, the coupling agent is selected from epoxidized vegetable oils, e.g., epoxidized soybean oil such as acrylated epoxidized soybean oil, epoxidized linseed oil, and mixtures thereof.

In embodiments, coupling agent is used in amounts of 1-15, or 2-14, or 3-12, or 5-10, based on total weight of the monomers to be polymerized.

After the sequential polymerization, polymers are hydrogenated in the presence of a hydrogenation catalyst at a temperature <350° C., or <250° C., or <100° C., or >50° C., and hydrogenation pressure of 500-900, or <1000, or >450 psig.

In embodiments, the hydrogenation reaction is conducted in the same solvent as is used for polymerization reaction, or a different solvent. Typically, the polymer solution obtained from the polymerization step is diluted further with additional solvent prior to hydrogenation to have a weight of the polymer in the solvent of 5-50, or 10-40 wt. %, based on total weight of the solution prior to hydrogenation.

In embodiments, the hydrogenation takes place in the absence of catalyst modifiers, until >90% of the aliphatic unsaturation is reduced and <30% of aromatic unsaturation has been reduced. At this point in embodiments, a catalyst modifier, e.g., a Lewis base, weak organic acids, alcohols, amines, etc., is added and hydrogenation continues at an increased temperature of 100-200° C., or 175-225° C., under pressure of ≥1000, 1100-2000, or 1200-1800 psig, until >40%, or >75% of the aromatic unsaturation has been reduced. Upon completion of hydrogenation step, >95%, or >98%, or >99% of the aliphatic unsaturation is reduced, and the aromatic unsaturation is reduced by at least 40%. In embodiments, a hydrogenation level of each block B, S, and “s” of >95%, independently, is obtained.

Following the end of the hydrogenation period, the catalyst residues can be removed by any of extraction, precipitation, filtration, or other means. The hydrogenation mixture is then treated to recover the f-HbBC such as by flashing off the solvent or coagulating the polymer with steam and/or hot water.

Examples of hydrogenation catalysts include transition metal catalysts, e.g., nickel, cobalt, or combinations thereof. The catalyst can be any heterogeneous catalyst that exists as dispersed sub-micron or colloidal particles, or a homogeneous catalyst. In embodiments, the catalyst is prepared by combining nickel or cobalt carboxylates or alkoxide with an alkyl or hydride of a metal selected from Groups I-A, II-A, and III-B of the Periodic Table of Elements (“cocatalyst”). In embodiments, the catalyst is formed by reacting cobalt or nickel carboxylic acid salt with other metal alkyls, e.g., Li alkyls including n-butyllithium and sec-butyllithium, or metal hydrides such as lithium hydride and lithium aluminium hydride. The reaction results in the formation of sub-micron particles that remain suspended in solvent indefinitely, in the manner of a colloidal suspension.

Examples of aluminum alkyl compounds include organo aluminum compounds of the formula RₙAlY₃₋ₙ, wherein R is a hydrocarbon group of C₁-C₁₀ or C₂-C₈, Y is hydrogen or R₂, wherein R₂ is a hydrocarbon group of C₁-C₁₀, which is different than R, and n is 1-3. In embodiments, the aluminum alkyl compound is trialkylaluminum compound. In embodiments, the aluminum alkyl compound has a molar ratio of aluminum to cobalt of 1:1 to 20:1, or 1:1 to 5:1 or 1:1 to 2:1.

Examples of soluble nickel or cobalt compounds include nickel carboxylates such as nickel octanoate, nickel stearate, nickel decanoate, nickel acetylacetanoate, nickel naphthenate, nickel octoate; and cobalt carboxylates such as cobalt stearate, cobalt octanoate, and cobalt versatate. In embodiments, the catalyst used is a mixture of cobalt and nick catalysts, e.g., a cobalt carboxylate with a nickel carboxylate. In embodiments, a cobalt catalyst used, with the amount of cobalt being at least 10%, or 25-75%, or at least 50% on a molar basis of the total metal present in the hydrogenation catalyst.

In embodiments, a hydrogenation catalyst is prepared by contacting the Group 8-10 metal compounds with one or more aluminum alkyls in a suitable solvent at a temperature from 20 to 100° C. and for 1 to 120 minutes. Suitable solvents include aliphatic hydrocarbons such as hexane, heptane, octane, and the like, cycloaliphatic hydrocarbons such as cyclopentane, cyclohexane, and the like, alkyl substituted cycloaliphatic hydrocarbons such as methylcyclopentane, methylcyclohexane, methyl cyclooctane, and the like, aromatic hydrocarbons such as benzene, hydroaromatic hydrocarbons such as decalin, tetralin, and the like, alkyl-substituted aromatic hydrocarbons such as toluene, xylene, and the like.

(Properties of f-HbBC)

In embodiments, the f-HbBC has a T_{g} of >145° C., or >150° C., or >155° C., or >160° C., or 145-200° C., or 150-190° C., or 155-180° C., or 160-190° C., as measured by DMA according to ASTM 4065.

In embodiments, the f-HbBC has a melt flow rate (MFR) of >0.1, or >0.5, or <10, or 0.1-35, or 0.5-25, or 1-20, or 1.5-15, or 0.5-10 g/10 minutes, measured at 260° C. with 5 kg load, according to ASTM D1238.

In embodiments, the f-HbBC has a VICAT softening point of >125° C., or >130° C., or 125-180° C., or 130-160° C., or 125-150° C., measured according to ASTM D1525.

In embodiments, the f-HbBC has a flexural modulus of at least 1500, or >1600, or >1700, or 1500-3000, or 1550-2500, or 1600-2200, or 1650-2000, or 1600-1850 MPa, measured according to ASTM D790.

In embodiments, the f-HbBC has an un-notched Charpy impact of at least 20, or 20-50, or 25-45, or 30-40, or 20-40, or 30-50 kJ/m², measured at 25° C. according to ASTM E23.

In embodiments, the f-HbBC has a shrinkage (machine direction) of <4%, or <3.5%, or <3%, or <2.5%, or <2%, or 0.5-4%, or 0.6-2% after injection molding, measured according to ASTM D955.

In embodiments, a film is prepared from the f-HbBC. In embodiments, the film has a thickness of 10 μm-5 mm, or 50 μm-3 mm, or 100 μm-2 mm, or 1 mm-4 mm.

In embodiments, the film has a haze of <15%, or <12%, or <10%, or <8%, measured according to ASTM D1003.

### (Applications)

The f-HbBC with high optics and high temperature resistance properties is particularly useful for a number of applications, e.g., optical films, lenses for use in camera, cell-phones, projectors, sensors, lighting applications, such as high brightness LEDs used in TV backlighting, LCD, traffic lights, and automotive lights, and general lighting purposes. The f-HbBC is also suitable for organic thin film solar cell applications where excellent UV resistance is required. The high T_{g} of the f-HbBC make it suitable to use in high power lens applications. The f-HbBC can also be used in many transparent medical device applications and in packaging applications as modifiers for other polymers including polypropylene, polyethylene, cyclic olefin polymers and copolymers, polyamides, etc. Other applications include fabricated articles, thermoformed articles, extruded articles, injection molded articles, films, and foams.

### EXAMPLES

The following examples are intended to be non-limiting.

Measurement methods in the examples include:

The glass transition temperature (T_{g}) was measured by Dynamic Mechanical Analysis (DMA) using a TA instruments DMA Q800, at a frequency of 1 Hz and a strain amplitude of 1% in the tensile oscillation mode, according to ASTM 4065. The tan 8 peak at the highest temperature representing the T_{g} of the hard phase (blocks obtained from vinyl aromatic monomers) is considered the T_{g} of the f-HbBC.

The radial block copolymers in the f-HbBC can be identified by using GPC and proton NMR. An exemplary GPC column is from Polymer Laboratories (PL-GPC), with a temperature range of 30 to 220° C., containing multi-heater oven to control the temperature to within 0.05° C. The radial block copolymers can be demonstrated (e.g., molecular weight, amounts, etc.) via the plurality of peaks on the GPC curve.

The components used in the examples include:

CE-1 is a pentablock copolymer (polycyclohexylethylene-ethylene-1-butene-polycyclohexylethylene) with 65 mol % hydrogenated polystyrene (>99% hydrogenation level) and 35 mol % of hydrogenated conjugated diene polymer block (>99% hydrogenation level), as disclosed in Patent Application Publication No. JP2021042329.

CE-2 is a polymodal branched block copolymer of styrene and butadiene as disclosed in Patent Publication No. U.S. Pat. No. 3,639,517.

### Example 1-Unhydrogenated Branched Block Copolymer Precursor

Preparation of unhydrogenated branched block copolymer (or precursor polymer) was prepared as follows. 458 lbs. of cyclohexane and 89 lbs. of styrene were charged to the reactor vessel. 0.77 lbs. of an approximately 12 wt. % solution of s-butyllithium in cyclohexane was added to initiate polymerization. An additional 60 lbs. of styrene was added at such a rate as to maintain the reaction temperature below 60° C. Following complete polymerization of the styrene, an additional 4.65 lbs. of s-butyllithium solution was added. The resulting solution, along with a 41 lbs. cyclohexane flush, was mixed with 77 lbs. of styrene, producing a population of high molecular weight chains by chain extension of the initial polystyrene block, as well as a population of low molecular weight chains resulting from reaction with the second initiator charge.

Following complete polymerization of the styrene charge, 75 lbs. of butadiene was added and allowed to polymerize, resulting in a population of high molecular weight, high polystyrene content chains (S-B) and lower molecular weight, lower polystyrene content chains (s-B). These chains were coupled by adding 1 lbs. of epoxidized soybean oil, followed by 0.03 lbs. of methanol to ensure complete termination.

### Example 2-f-HbBC Polymer

90 grams of the precursor polymer prepared in example 1 was dissolved in cyclohexane to a 10 wt. % solution. The polymer solution and 6-9 grams of cobalt hydrogenation catalyst in cyclohexane solution were charged to the reactor. Temperature and pressure were gradually increased to 200° C. and 800 psig over 16 hours, during which 27 grams of additional catalyst was added, until conversion of polystyrene was >97%. The solution was contacted with acidic water to extract the metals, then neutralized. 0.05 wt. % of each antioxidants, Irganox 1010 and Irgafos 168, were added and the f-HbBC (with mixture of (S-B)ₙX(s-B)ₘ and (s-B)_{z}X; n≥1, m+n≥3, and z=2 to 4) recovered by precipitation and drying in a vacuum oven. Residual unsaturation of diene and polystyrene was <2% and <3%, respectively.

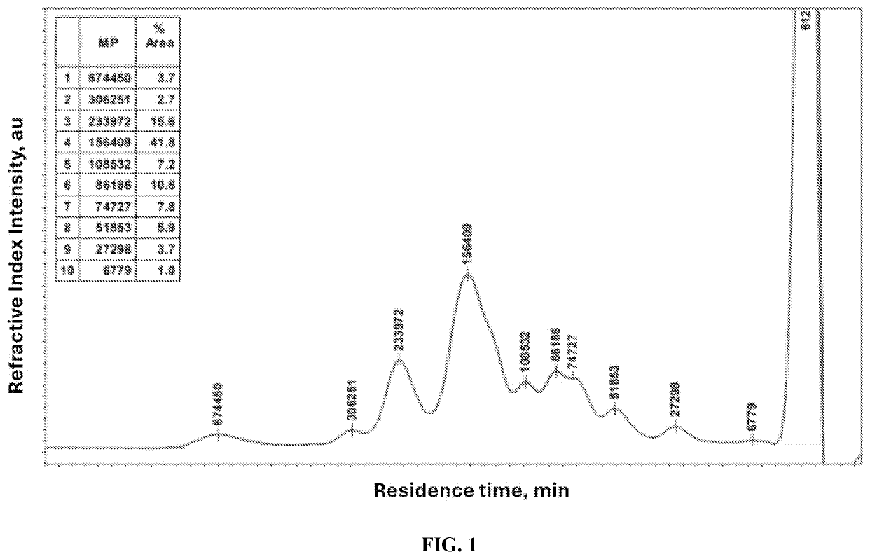

GPC analysis of the f-HbBC is as shown in FIG. 1, 71% of radial block copolymers has a molecular weight (Mₚ) of >100 kg/mol and 29% of radial block copolymers has a molecular weight (Mₚ) of <100 kg/mol.

Details of the composition of the f-HbBC are presented in table 1. Table 2 compares properties of the f-HbBC and comparative examples.

TABLE 1

| | | Mol | | | | | | | Hydro- | Hydro - | | |
|---|---|---|---|---|---|---|---|---|---|---|---|---|
| | Mol | Wt. | | | Mol. | | | | genation | genation | | |
| | Wt. | of | | | Wt. | | | | level of | level of | | |
| | of | block | | | of | | | | each | each | (S-B)ₙX(s-B)ₘ | |
| | block | “s” | | | f-HbBC | | | PVCH | block S | block | (n ≥ 1, m + | (s-B)_{z}X |
| | S (kg/ | (kg/ | PSC | CE | (kg/ | | Tg | Content | and “s” | B | n ≥ 3) | (z = 2 to 4) |
| | mol) | mol) | (%) | (%) | mol) | PDI | (° C.) | (%) | (%) | (%) | (wt. %) | (wt. % ) |
| Exam- | 113.5 | 9.2 | 75 | 75 | 179 | 1.89 | 163 | 75 | 99 | 99 | 56 | 22 |
| ple- | | | | | | | | | | | | |
| 2 | | | | | | | | | | | | |

The f-HbBC is compared with block polymers of the prior art, a pentablock (CE-1) and a polymodal branched block copolymer (CE-2).

TABLE 2

| | Comparative example | Comparative example | |
|---|---|---|---|
| | (CE-1) | (CE-2) | Example 2 |
| T_{g} [pk tanδ] (° C.) | 129 | <105 | 163 |
| MFR (g/10 minutes) | 1.3 (230° C./2.16 kg) | 0.9 to 3.9 | 1.7 (260° C./5 kg) |
| | | (200° C./5 kg) | |
| Flexural modulus (MPa) | 2300 | 1737-2103 | 1720 |
| Charpy Impact (un-notched) (kJ/m²) at | — | — | 33.7 |
| 25° C. | | | |
| VICAT softening point (° C.) | — | — | 134 |
| Shrinkage (machine direction) (%) | — | — | 1 |
| Haze (%) (Sample thickness of 2 mm) | — | 2.5-3.2 (10 mil) | 6.9 |

As shown, the f-HbBC of example 2 shows much better Charpy Impact (un-notched) and T_{g}, and still retaining low haze value over the comparative example CE-1. It is known that the T_{g} of a polystyrene block (not hydrogenated) such as comparative example CE-2 cannot exceed 105° C. which is the theoretical maximum T_{g} of homopolystyrene.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items.

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

Unless otherwise specified, all technical and scientific terms used herein have the same meanings as commonly understood by one of skill in the art to which the disclosed disclosure belongs. the recitation of a genus of elements, materials, or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A fully hydrogenated branched block copolymer, comprising a mixture of radial block copolymers having a general structure of (S-B)ₙX(s-B)ₘ, (s-B)_{z}X, and mixtures thereof,
wherein prior to hydrogenation:
each block S and “s” independently is a polymer block of a vinyl aromatic monomer,
each block B is a polymer block of a conjugated diene monomer,
X is residue of a coupling agent,
m>n, n≥1, m=1 to 20, z=2 to 4, and m+n≥3;
wherein after hydrogenation:
the radial block copolymers demonstrating a plurality of peaks on a GPC curve;
the mixture comprises at least 70 wt. % of a poly(vinylcyclohexane) content, and less than 30 wt. % of a hydrogenated polymer block of a conjugated diene monomer, based on total weight of the mixture;
at least 60% of radial block copolymers in the mixture have a molecular weight (Mₚ) of >100 kg/mol, with remainder having a molecular weight (Mₚ) of <100 kg/mol;
at least 30% of radial block copolymers in the mixture have a molecular weight (Mₚ) of at least 120 kg/mol, with remainder having a molecular weight (Mₚ) of <120 kg/mol;
less than 40 wt. % of the mixture having a general structure of (s-B)_{z}X; and
wherein the fully hydrogenated branched block copolymer has:
a polydispersity index of >1.20,
a glass transition temperature (T_{g}) of >145° C.,
a MFR of >0.1 g/10 minutes, measured at 260° C. with 5 kg load, and
an un-notched Charpy Impact strength of at least 20 KJ/m² measured at 25° C.

2. The fully hydrogenated branched block copolymer of claim 1, wherein the mixture has a weight ratio of radial block copolymers having a structure of (S-B)ₙX(s-B)ₘ to radial block copolymers having a structure of (s-B)_{z}X of 1:1 to 20:1.

3. The fully hydrogenated branched block copolymer of claim 1, wherein at least one radial block copolymer has a molecular weight (Mₚ) of 120 to 250 kg/mol.

4. The fully hydrogenated branched block copolymer of claim 1, wherein the mixture of radial block copolymers comprises 60 to 80% of radial block copolymers having a molecular weight (Mₚ) of >100 kg/mol and 20 to 40% of radial block copolymers having a molecular weight (Mₚ) of <100 kg/mol.

5. The fully hydrogenated branched block copolymer of claim 4, wherein radial block copolymers with the molecular weight (Mₚ) of >100 kg/mol has at least one block S, and radial block copolymers with the molecular weight (Mₚ) of <100 kg/mol has no block S.

6. The fully hydrogenated branched block copolymer of claim 1, wherein the fully hydrogenated branched block copolymer has a polydispersity index of 1.20 to 3.0.

7. The fully hydrogenated branched block copolymer of claim 1, wherein radial block copolymers comprise 50 to 80 wt. % of (S-B)ₙX(s-B)ₘ and 20 to 40 wt. % of (s-B)_{z}X, based on total weight of the radial block copolymers.

8. The fully hydrogenated branched block copolymer of claim 1, wherein radial block copolymers comprise 70 to 85 wt. % of (S-B)ₙX(s-B)ₘ and (s-B)_{z}X structures, based on total weight of radial block copolymers.

9. The fully hydrogenated branched block copolymer of claim 1, wherein each block S, “s”, and B is independently hydrogenated to a level of >95%, as determined by proton NMR.

10. The fully hydrogenated branched block copolymer of claim 1, wherein the fully hydrogenated branched block copolymer has a poly(vinylcyclohexane) content of 70 to 95%.

11. The fully hydrogenated branched block copolymer of claim 1, wherein the fully hydrogenated branched block copolymer further comprises other arm distributions selected from (s-B) 4, (s-B) 3, (s-B) 2, and mixtures thereof, and uncoupled arms selected from S-B, s-B, and mixtures thereof, combined in an amount of 15 to 25 wt. % of, based on total weight of the fully hydrogenated branched block copolymer.

12. The fully hydrogenated branched block copolymer of claim 1, wherein the block S has a molecular weight (Mₚ) of 110 to 140 kg/mol, and the block “s” has a molecular weight (Mₚ) of 7 to 12 kg/mol.

13. The fully hydrogenated branched block copolymer of claim 1, wherein the fully hydrogenated branched block copolymer has a polystyrene content, prior to hydrogenation, of 70 to 95%.

14. The fully hydrogenated branched block copolymer of claim 1, wherein the coupling agent is selected from the group consisting of polyepoxides, polyisocyanates, polyamines, polyaldehydes, polyhalides, polyanhydrides, polyketones, polypoxyesters, polyesters, and mixtures thereof.

15. The fully hydrogenated branched block copolymer of claim 1, wherein the fully hydrogenated branched block copolymer has a coupling efficiency of 70 to 90%.

16. The fully hydrogenated branched block copolymer of claim 1, wherein the fully hydrogenated branched block copolymer has a glass transition temperature (T_{g}) of 145 to 200° C.

17. The fully hydrogenated branched block copolymer of claim 1, wherein the fully hydrogenated branched block copolymer has a glass transition temperature (T_{g}) of 150 to 190° C.

18. The fully hydrogenated branched block copolymer of claim 1, wherein the fully hydrogenated branched block copolymer when formed into a film having a thickness in the range of 1 mm to 4 mm, demonstrating a haze of <15% as determined by ASTM D1003.

19. The fully hydrogenated branched block copolymer of claim 1, wherein the fully hydrogenated branched block copolymer has a melt flow index of 0.1 to 35 g/10 minutes, measured at 260° C. with 5 kg load.

20. The fully hydrogenated branched block copolymer of claim 1, wherein the fully hydrogenated branched block copolymer has at least one of:
a flexural modulus of at least 1500 Mpa;
a VICAT softening point of 125 to 180° C.;
an un-notched Charpy impact of 20 to 50 kJ/m²; and
a shrinkage (machine direction) of <4%, after injection molding.
